(19) United States
(12) Patent Application Publication
(10) Pub. No.: US 2023/0289693 A1
(43) Pub. Date: Sep. 14, 2023

(54) INTERACTIVE WHAT-IF ANALYSIS SYSTEM BASED ON IMPRECISION SCORING SIMULATION TECHNIQUES

(71) Applicant: INTERNATIONAL BUSINESS MACHINES CORPORATION, Armonk, NY (US)

(72) Inventors: Wen Pei Yu, Xian (CN); Xiao Ming Ma, Xi'an (CN); Xue Ying Zhang, Xi'an (CN); Si Er Han, Xi'an (CN); Jing James Xu, Xi'an (CN); Jing Xu, Xi'an (CN); Rui Wang, Xian (CN); Jun Wang, Xi'an (CN); Ji Hui Yang, Beijing (CN)

(21) Appl. No.: 17/654,612

(22) Filed: Mar. 14, 2022

(51) Int. Cl. G06Q 10/06; G06F 11/34

(52) U.S. Cl. CPC G06Q 10/06375; G06F 11/3457

(57) ABSTRACT

A method, computer system, and a computer program product for performing an interactive outcome analysis is provided. The present invention may include generating, by a computer, a first estimation outcome from a first plurality of input conditions. The present invention may include generating, by the computer, a parallel estimation outcome from a second plurality of input conditions, wherein at least one of said input conditions in said first plurality of input conditions is different from any of said second plurality of input conditions. The present invention may include selecting, by the computer, either said first or said parallel estimation outcome by analyzing said outcomes with one another and with a target goal outcome.

### BACKGROUND

The present invention relates generally to the field of computer implemented process analysis, and more particularly to techniques for simulating interactive analysis systems based on an imprecision scoring simulation.

In logic and math, analysis may often be referred to as a technique of breaking down a process into smaller parts to gain better control on the process' outcome. Process analysis may allow for efficient streamlining, through better understanding and manipulating of the process components. Analysis may be very important in the successful outcome of a process because it helps anticipate possible issues that may arise.

With the advent of mathematical and technological advancements of recent years, statistical models have been developed to provide process analysis. Different methods of sensitivity analysis have become available, including scenario-management tools, brainstorming techniques, and modeling and simulation techniques. One of these analysis methods may be the so called “what-if analysis” model. This model may be developed to further control process efficiency and perform better risk assessment of potential problems that may impact successful process completion.

The main purpose of “what-if analysis” models may be to allow for the determination of how projected performance of a process can be affected by changes in the assumptions that projections are based upon. A what-if analysis may be used to compare different scenarios and their potential outcomes based on fluctuating conditions. In some of the cases, the “what-if analysis” models may allow for the changing of the values of input conditions to allow a prediction of how such changes will affect the overall outcome.

### SUMMARY

Embodiments of the present invention disclose a method, computer system, and a computer program for generating an interactive outcome analysis. The present invention may include generating, by a computer, a first estimation outcome from a first plurality of input conditions. The present invention may include generating, by the computer, a parallel estimation outcome from a second plurality of input conditions, wherein at least one of said input conditions in said first plurality of input conditions is different from any of said second plurality of input conditions. The present invention may include selecting, by the computer, either said first or said parallel estimation outcome by analyzing said outcomes with one another and with a target goal outcome.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides a flowchart illustration of a method according to one embodiment.

FIG. 3a provides an illustration of input provided for analysis according to at least one embodiment;

FIG. 3b provides an illustration of a tabulated input and correlating graphical rendering of what-if expected and actual target results according to at least one embodiment;

FIG. 3c provides a graphical rendering of a parallel what-if analysis relating to embodiment of FIG. 2b according to at least one embodiment;

FIG. 3d provides an example of two different input sets of data with a resultant what-if analysis result according to at least one embodiment;

FIG. 4 provides a block diagram showing generation of associated scores generated by an engine for an original what-if input and for parallel inputs according to at least one embodiment;

FIG. 5 illustrates a block diagram having a drag and drop interactive embodiment similar to the one provided in FIG. 4;

FIG. 6 provides a graphical rendering showing ICE values showing prediction as a function of changing feature interval according to one embodiment;

FIG. 7 provides a graphical rendition such as in the embodiment of FIG. 6 illustrating the turning point instances, according to one embodiment

FIG. 8 provides a block diagram illustrating the turning points of FIG. 7 in greater detail according to one embodiment;

FIG. 9 provides a block diagram of internal and external components of computers and servers depicted in FIG. 1 according to at least one embodiment;

FIG. 10 provides a block diagram of an illustrative cloud computing environment including the computer system depicted in FIG. 1, in accordance with an embodiment of the present disclosure; and

FIG. 11 provides a block diagram of functional layers of the illustrative cloud computing environment of FIG. 10, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As discussed, in recent years efficiency and risk avoidance of processes have become of greater importance, especially with the current technical advancements such as Artificial Intelligence (AI). This had led to the design and development of a what-if analysis.

Unfortunately, the prior art models, even when using “what-if analysis” techniques may not allow the users to understand how changes to the input affect the overall outcome. This may be particularly true when multiple input changes have occurred. In such cases, it may be possible that only a single input change, amongst many, has led to a particular outcome. However, the user or the designer of the process may be unaware of the latter. This may lead to poor risk management and also to inefficiencies in controlling the process. It is important to understand the impact of each input condition to achieve desired target values despite realistic issues that may arise during process completion. While it may be easy to see the result such as by simulation and corresponding analysis for a set of input values, it may not always be easy to appreciate if alternative input values would provide better advantages.

Therefore, it may be desirous to provide a “what-if analysis” type model that can predict a desired target output based on changing input. It may also be desirous to a have a model that allows the users and designers of processes to understand how each input change can impact and hinder successful completion and outcome of the process.

Furthermore, it may be advantageous to, among other things, provide a technique to find parallel what-if analysis for a certain task based on alternate set of input that may be very different or similar in values with the original set of values. In this manner, converging points around changed features that will cause a different effect can be reviewed and altered to achieve a desired target goal.

The following described exemplary embodiments provide a system, method and program product for task management. As such, the present embodiment has the capacity to improve the technical field of task management and completion by more optimally assigning tasks, automating at least part of such tasks and monitoring their completion and make timely reassignments as necessary. More specifically, the present invention may include generating, by a computer, a first estimation outcome from a first plurality of input conditions. The present invention may include generating, by the computer, a parallel estimation outcome from a second plurality of input conditions, wherein at least one of said input conditions in said first plurality of input conditions is different from any of said second plurality of input conditions. The present invention may include selecting, by the computer, either said first or said parallel estimation outcome by analyzing said outcomes with one another and with a target goal outcome

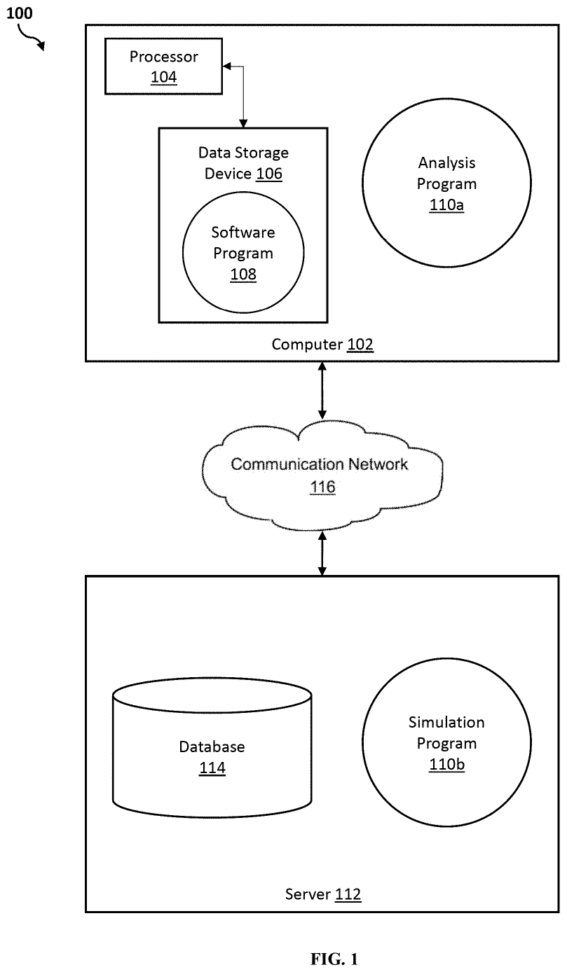

FIG. 1 provides an exemplary networked computer environment 100 in accordance with one embodiment. The networked computer environment 100 may include a computer 102 with a processor 104 and a data storage device 106, enabled to run a software program 108 and an analysis program 110a. The networked computer environment 100 may also include a server 112, enabled to run a simulation application or program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

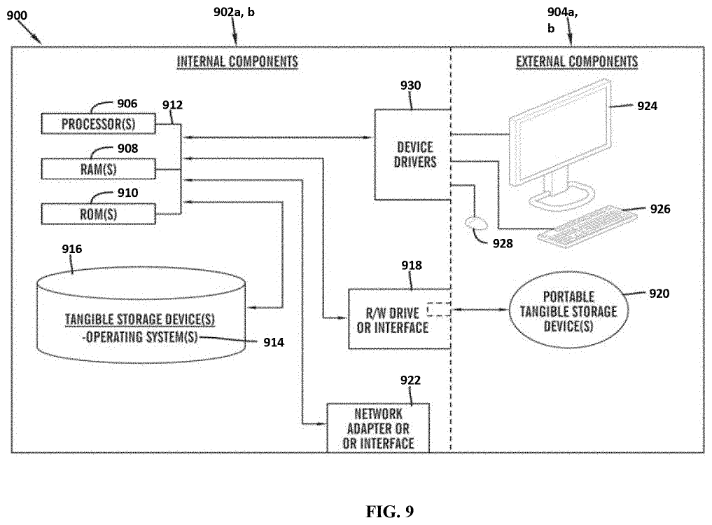

The client computer 102 may communicate with the server computer 112 via the communications network 116. The communications network 116 may include connections, such as wire, wireless communication links, or fiber optic cables. As will be discussed with reference to FIG. 9, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as an exclusive cloud, community cloud, public cloud, or hybrid cloud. Client computer 102 may be, for example, a mobile device, a telephone, a customized digital assistant, a netbook, a laptop computer, a tablet computer, a desktop computer, or any type of computing devices capable of running a program, accessing a network, and accessing a database 114. According to various implementations of the present embodiment, analysis application 110a, and simulation application/program 110b may interact with a database 114 that may be embedded in various storage devices, such as, but not limited to a computer/mobile device 102, a networked server 112, or a cloud storage service.

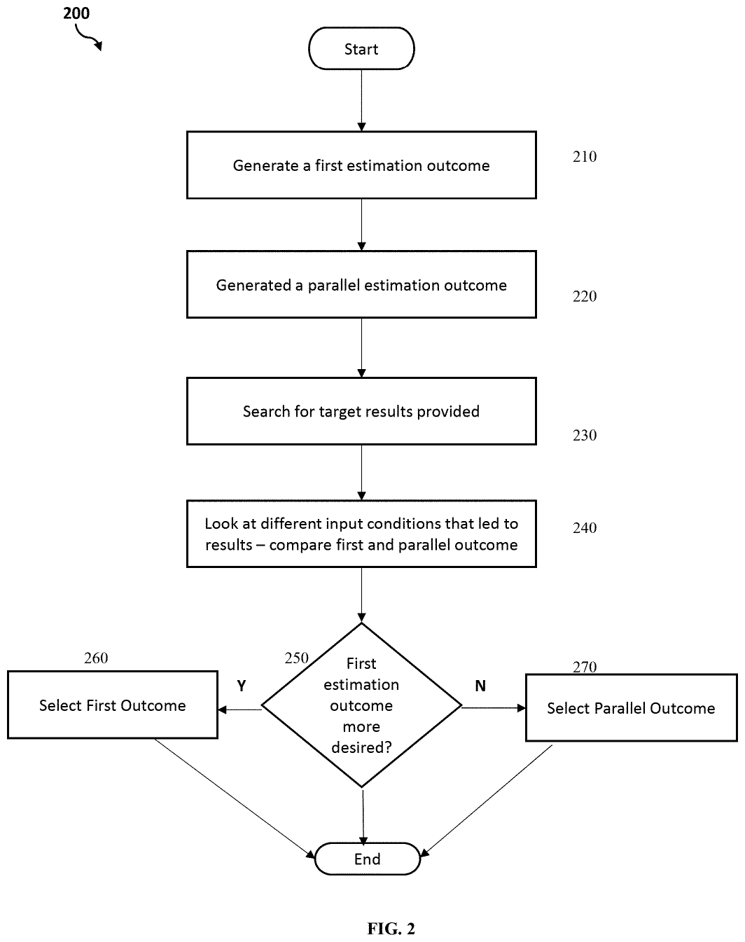

According to the present embodiment, a user using a client computer 102 or a server computer 112 may use the program 110a, 110b (respectively) to provide a task management technique. This technique will be provided in more detail below with respect to FIGS. 2 through 8.

FIG. 2 is a flowchart illustration of one embodiment for techniques to using “what-if” analysis of an original set and an altered parallel set, even in an interactive manner to achieve a desired target outcome goals and results. As provided in FIG. 2 a first plurality of input conditions and a second plurality of input conditions are provided. In one embodiment, these input conditions are provided to a simulator engine or an application that simulates outcomes.

In step 210, a first estimation outcome may be generated based on the first plurality of input conditions. These conditions may be provided by a user based on desired or expected results. In other embodiment, the input conditions may be automatically obtained from other application or program, including online resources. For example, in one scenario the outcome result may be the number of new constructions that will be started for a construction company A. One set of input conditions may be the temperature and humidity (overall weather conditions) for each month between January and September. This set of input conditions will be taken from historical averages. A second set of input results may be the number of workers available during each month and this information may be inputted directly by an administrator of Company A.

In step 220, a parallel estimation outcome from a second plurality of input conditions. This plurality of parallel input conditions, in the example of the scenario used previously could for example encompass different weather conditions, for example taking low temperatures as opposed to high or average temperatures used previously. In another embodiment, the number of workers may be changed based on possible plans to hire more (or less workers). At least one, but possibly many of the input conditions will be different between the first and second plurality of input conditions to allow for a different outcome to be generated between the first and parallel outcome.

In step 230, provide an alternate embodiment where a target outcome can be provided. A target outcome can be one that is predictively expected by the user. In one embodiment, the target outcome may be previously inputted by the user or even generated as an optimal outcome based on the input provided by a simulator or other computers. In such a case, a scenario can be provided as an example where the outcomes generated provide a projected expense generated for company A. In this example, a first outcome generates a $200,000 expenditure while the parallel outcome generates a $300,000 expenditure prediction. In order to subsequently chose one of the two outcomes, a target outcome of $250,000 may be inputted by a user or by a computer system or automated machine. If such a target outcome is input and stored previously, this will then allow the two outcomes to be compared to it.

In step 240, the two (or a plurality in some embodiments) of outcomes that are generated are analyzed. This analysis can include both the overall outcome and the reasons that led to the outcome. If there are any target outcome results previously provided to the stimulator or other computer or computer systems, that information will also be retrieved and analyzed. It should be noted, that generated outcomes do not have to be limited to two only and a variety of outcomes can be generated for a plurality sets of input conditions (generated in step 210 and 220). Furthermore, the analysis and/or the results can be presented to the user in a variety of manners (different renditions), as will be shown later. In one example, this can even be provided as side-by-side renderings on a same screen or page. In another embodiment, the input conditions can be changed interactively, until a desired target outcome can be achieved.

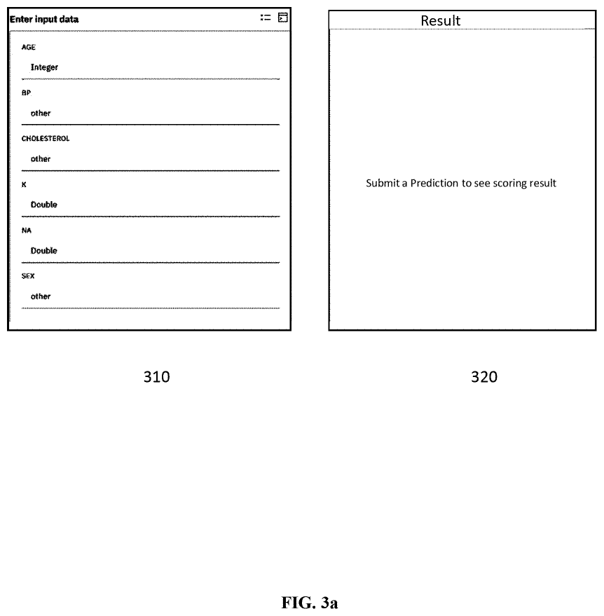

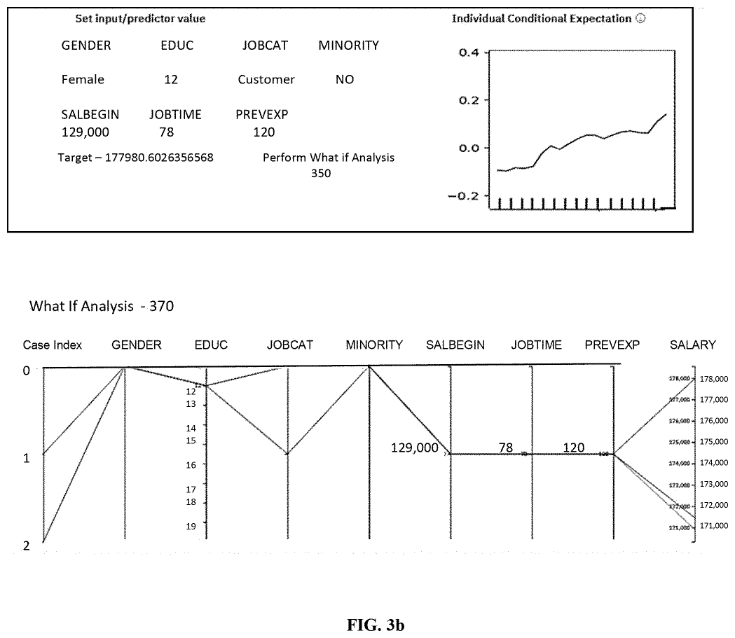

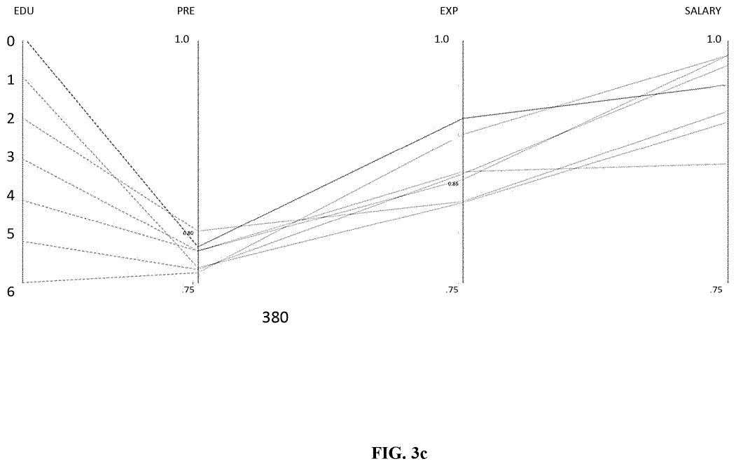

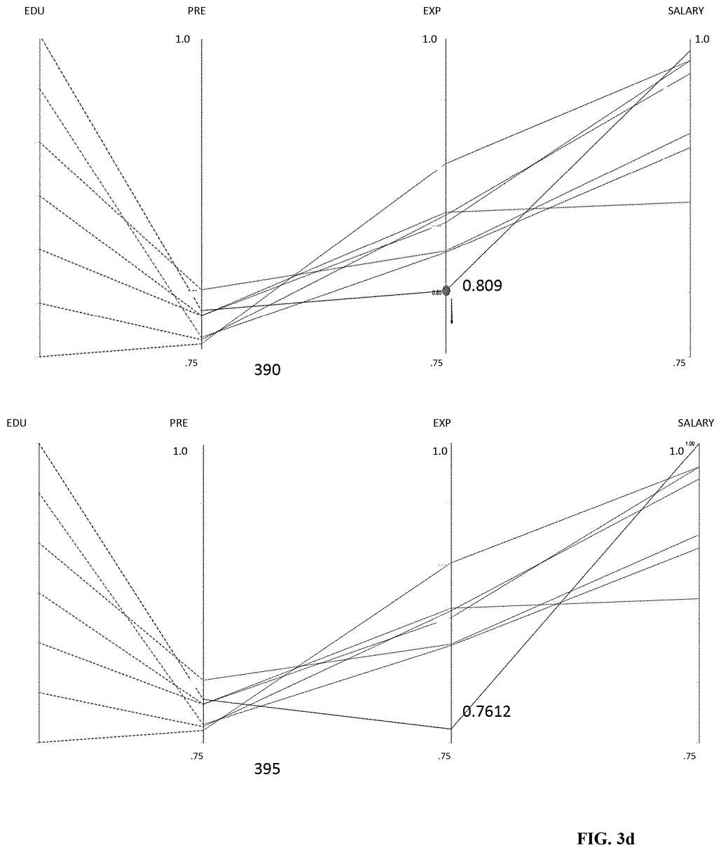

Some examples are explored through the figures (FIG. 3-8) and different embodiments as will be discussed to display the ease of design and flexibility as could be obtained through different embodiments. For example, in one embodiment, an intended set of input can be analyzed and measured against one or a plurality of parallel different outcomes. The parallel input sets (e.g., described previously with respect to steps 210 and 220) can be entirely different, somewhat different or substantially the same to allow the greatest flexibility for the user to perform what-if analysis and subsequent comparison. In another embodiment, for example, the programs 110a and 110b (e.g., the analysis program 110a and the simulation program 110b) of FIG. 1 can be used such as to provide support for one or more input predictor values, such as known by those skilled in the art.

Finally in step 250, a decision is made as which of the outcomes (in this example the first and parallel outcome) may be considered to be more desirous based on the analysis made in step 240. The decision as which of the two or more options are to be selected depend on the analysis step and can involve variety of factors. For example when there was a target goal, the two (plurality of outcomes) will be measured against this target. In other situations where input conditions were changed interactively, the final outcome may already be selected.

Ultimately, one or the other outcome is recommended as provided in steps 260 (where a first outcome is selected) and 270 (where a parallel outcome is selected). A rendering can then be provided (not illustrated in this flowchart). It should be noted, however, that the final selection of step 260 or 270 may be more complex than just comparing the outcomes with a final target, even when one may be provided. For example, both the outcome goal and a variety of inputs may be selected as targets. For example, both the target goal of $250,000 and a condition that no more than 5 workers will be used in month of December may be used and the final selection will then not only depend on the final goal outcome but also in satisfying the condition.

Many alternate embodiments can be used, but one example can be through a drag-drop menu having a corresponding dimension with the parallel analysis or chart, when applicable. In this scenario, the system and program can calculate and label out one or more important turning points that can cause a different effect that can relate to or detract from the target goal. In yet, another embodiment a batch evaluation can be performed to provide a simulation of a method to improve performance of this operation (e.g., via the drag-drop operation/menu). These and more such scenarios will now be explored by the examples and embodiments provided in FIGS. 2-8 to provide ease of understanding, yet alternate embodiments are possible that vary from these.

FIGS. 3a to 3d, provide one embodiment where input may be provided to generate a first analysis and a parallel analysis. In FIG. 3a, provides an illustration of the input shown at 310 and a possible outcome or prediction 320 not yet generated. In FIG. 3b, an expanded view provides input values that can be tabulated, or such as shown at 350. In one embodiment an individual conditional expectation chart or graph can be generated at 360. The actual what-if analysis can be then conducted, and a graph generated at 370. FIG. 3c shows the generation of a parallel what-if analysis that also be charted as a graph as shown at 380. The latter can be generated based on a secondary set of input values, provided by the user as a comparison base or for any other reason (even by a machine learning algorithm or artificial intelligence system to reflect a range of possibilities such as optimal results, real life situations that may impact input, a competitor's input result etc.).

In the example shown in the figure, the user can easily see the changes and detractions that changing one or more input differences (350) has caused by visually seeing the differences between the graphs 370 and 380. The comparison with the parallel chart 380 can also be used for a multi-dimensional record comparison. In this latter scenario, the parallel chart can be applied for a what-if analysis to help the user understand existing or future relationships easily so as to enable correct choices and timely changes needed for the input to achieve a desirable target.

FIG. 3d provides for an example of an interactive analysis having a different set of inputs. A first set of input can be provided at 390 achieving a final result of 0.809. As the rendering can be being changed, a second set of input can be provided interactively to achieve a final result at 395 of 0.7612. It may be difficult to realize, according to this example, as to how the user may lock the first result (e.g., such that no further changes can be made) after inputting it after achieving the final result of 390 (0.809) for later comparison as the input can be being changed to achieve the desired result of 395 (0.7612). In one embodiment, the graphical rendering of 390 may appear on the side while the input may be further changed and managed to achieve the results in 395. That result (395) can also be locked. The final step produced in FIG. 3 may allow the user to see both the final result (0.809 vs. 0.7612) and all the input for both sets to achieve each result. In another embodiment, there may be no locking needed and once one set of input can be provided completely, the rendering can be created and used against other sets inputted to have one or more parallel sets of renderings. One advantage can be that once (as seen in FIG. 3d), the input for 390 can be provided, the user can iteratively experiment with the input to achieve a final desired result (target or goal outcome) at 395. The input for achieving the set of 395 may not be known at all initially, but achieved through iteratively changing the input conditions, until a final result may be achieved that may be similar or identical to the target outcome. In another embodiment, the result can be provided to a simulation. The input needed can then be created and rendered (opposite set) 390 to enable a user to appreciate whether such input may be desirable or achievable. In this scenario, a value or range of values for the outcome may be provided to the simulation engine and input conditions are manipulated by the engine until the target outcome can be achieved.

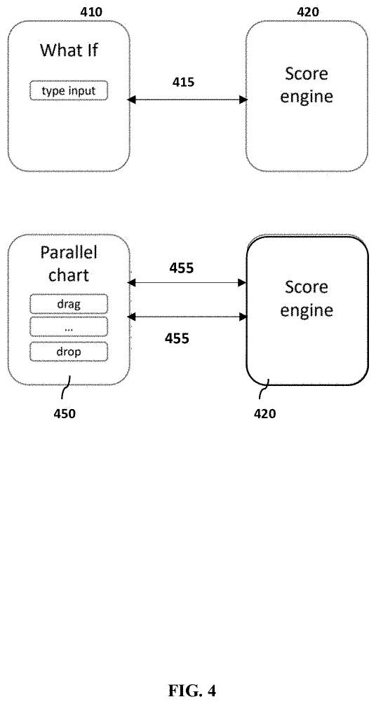

FIG. 4 provides an illustration of a block diagram according to one embodiment. In the embodiment of FIG. 4, the analysis of the input 410 into simulation engine also has a scoring engine that can measure and render analysis results, The score engine 420 will provide a scoring result for both the original what-if input conditions (shown as 415) or the parallel results 450. In this example, the parallel what-if has a plurality of input conditions for consideration as shown at 455 collectively (the arrows each are a different input set). This will enable the user (or a program or artificial intelligence) to interactively rate and score the results based on a plurality of factors (such as a target outcome), either as defined by the simulation system itself or based on a number of user defined parameters previously or simultaneously defined. In one embodiment, each value generated can be an individual conditional expectation (ICE) based on user expectation or general expectation as determined by the system or the engine 420. This is shown for one of the paths 455 of FIG. 4

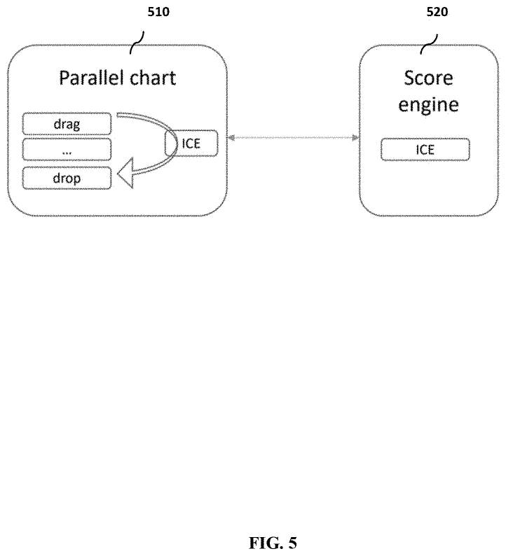

FIG. 5, provides a block diagram illustrating the generation of ICE for reach set of input (pathway 455). In this embodiment, user can utilize an interactive drag and drop (e.g., Menu) operation as shown at 510 for each process and a corresponding result 520.

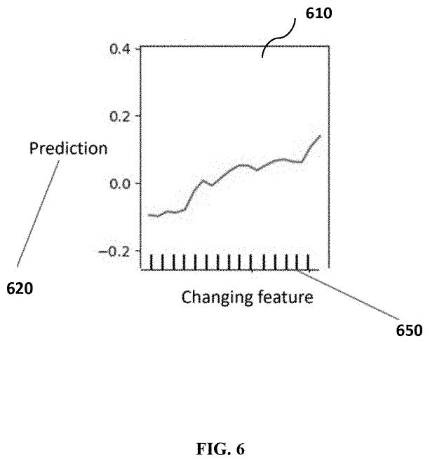

FIG. 6 provides a more detailed look of generation of ICE (such as presented in FIG. 5.) In the embodiment illustrated in FIG. 6 the Individual Conditional Expectation (ICE) values are computed the very moment or instant the input affects the results and changes the prediction. In FIG. 6, the graphical rendering shows on the y-axis a rendition measuring prediction value (zero change when the other remains unchanged) versus the interval between two adjacent features 620 (x-axis) as shown at 610 when a feature changes in specified range with same interval 650 while other features value remain unchanged. In other words, this ICE computes the instance a prediction changes—when a feature changes—in a specified range 650 with same interval while the other features value remain unchanged.

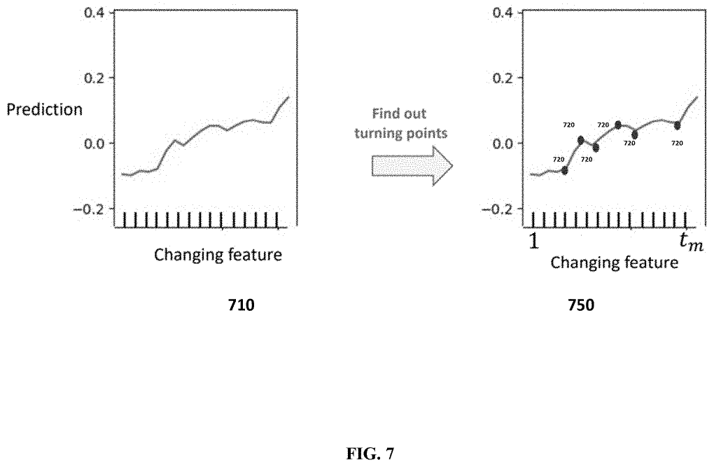

FIG. 7 provides a block diagram showing renderings such as the one in FIG. 6. In FIG. 7, a similar diagram generated in FIG. 6 can be generated as shown at 710. In 750, however, the analysis and engine has identified and calculated changes. Therefore, in FIG. 7, the engine has both analyzed and calculated the turning points 720 using the ICEE prediction values as a sequence but provided these values on the graph of FIG. 7. In this scenario, the trend value and direction of adjacent intervals marked by turning points are different. In this embodiment since the measurements on the x axis are defined to be between 0/1 and tₘ, and the feature values marks as date/time tᵢ from 1 to T while the prediction values range from TCₜᵢ at [t₁ . . . tₘ].

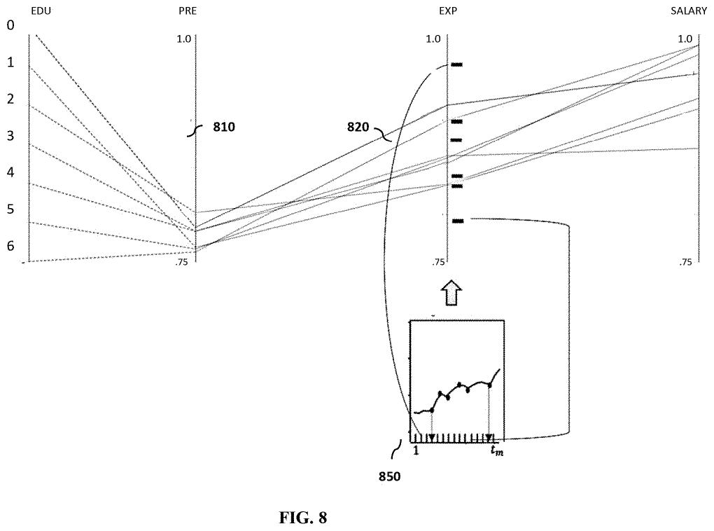

FIG. 8, illustrates the turning points 720 of FIG. 7 in more detail. As illustrated, FIG. 8 provides the mark feature value(s) 850 of each of the turning points in the parallel axis.

In one embodiment, an algorithm may be used to find these values. An example of such an algorithm follows, however other algorithms may be used.

### Example—Algorithm

A turning point may be a date/time direction of TCᵢ series changes. The direction can be based on the steps below:
a) Find out the candidate turning points t₁, t₂, . . . tₘ at which the trend direction changes (i.e., a point tᵢ satisfies one of the following conditions:

TCₜᵢ₋₁−TCₜᵢ≤0 and TCₜᵢ−TCₜᵢ₊₁>0

TCₜᵢ₋₁TCₜᵢ≥0 and Tcₜᵢ−TCₜᵢ₋₁<0
b) Delete the candidate turning point:

tᵢ if tᵢ₊₁−t≤2
c) Adjustment—For a candidate turning point tᵢ at which the trend starts to decrease (increase), adjust it to tᵢ if the original time series value at t reaches the maximum (minimum) in the interval [tᵢ−2, tᵢ+2].
d) Let t₀=1 and tₘ₊₁=n. At each candidate turning point tᵢ. if the following two conditions hold, then t=tᵢ is a turning point.

|TCₜᵢ−TCₜᵢ₊₁|/|TCₜᵢ|≥c₁% or |TCₜᵢ−TCₜᵢ₋₁|/|TCₜᵢ₋₁|≥c₁%, where default values for c₁ is 20.

tᵢ₊₁−tᵢ≥c₂ and tᵢ−tᵢ₋₁≥c3, where the default values for c₂ and c₃ are 5.

The output turning point may be tᵢ and the candidate point may be tᵢ₋₁ and tᵢ₊₁

FIG. 9 provides a block diagram 900 of internal and external components of computers depicted in FIG. 1 in accordance with an illustrative embodiment of the present invention. It should be appreciated that FIG. 9 provides only an illustration of one implementation and does not imply any limitations with regard to the environments in which different embodiments may be implemented. Many modifications to the depicted environments may be made based on design and implementation requirements.

Data processing system 902, 904 may be representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, individual computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 9. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the analysis program 110a in client computer 102, and the simulation program 110b in network server 112, may be stored on one or more computer-readable tangible storage devices 916 for execution by one or more processors 906 via one or more RAMs 908 (which typically include cache memory). In the embodiment illustrated in FIG. 9, each of the computer-readable tangible storage devices 916 may be a magnetic disk storage device of an internal hard drive. Alternatively, each of the computer-readable tangible storage devices 916 may be a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108, the analysis program 110a and simulation program 110b can be stored on one or more of the respective portable computer-readable tangible storage devices 920, read via the respective RAY drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the analysis program 110a in client computer 102 and the simulation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the analysis program 110a in client computer 102 and the simulation program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is to be understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
a. On-demand self-service: a cloud consumer can unilaterally provision computing capabilities, such as server time and network storage, as needed automatically without requiring human interaction with the service's provider.
b. Broad network access: capabilities are available over a network and accessed through standard mechanisms that promote use by heterogeneous thin or thick client platforms (e.g., mobile phones, laptops, and PDAs).
c. Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
d. Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
e. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
f. Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
g. Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
h. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
i. Exclusive cloud: the cloud infrastructure is operated solely for an organization. It may be managed by the organization or a third party and may exist on-premises or off-premises.
j. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
k. Public cloud: the cloud infrastructure is made available to the general public or a large industry group and is owned by an organization selling cloud services.
l. Hybrid cloud: the cloud infrastructure is a composition of two or more clouds (exclusive, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

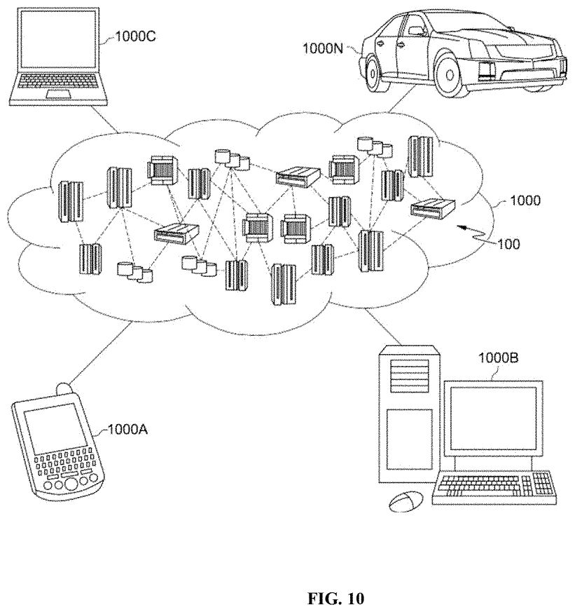

Referring now to FIG. 10, illustrative cloud computing environment 1000 is depicted. As shown, cloud computing environment 1000 comprises one or more cloud computing nodes 100 with which local computing devices used by cloud consumers, such as, for example, digital assistants (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as exclusive, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 10 are intended to be illustrative only and that computing nodes 100 and cloud computing environment 1000 can communicate with any type of computerized device over any type of network and/or network addressable connection (e.g., using a web browser).

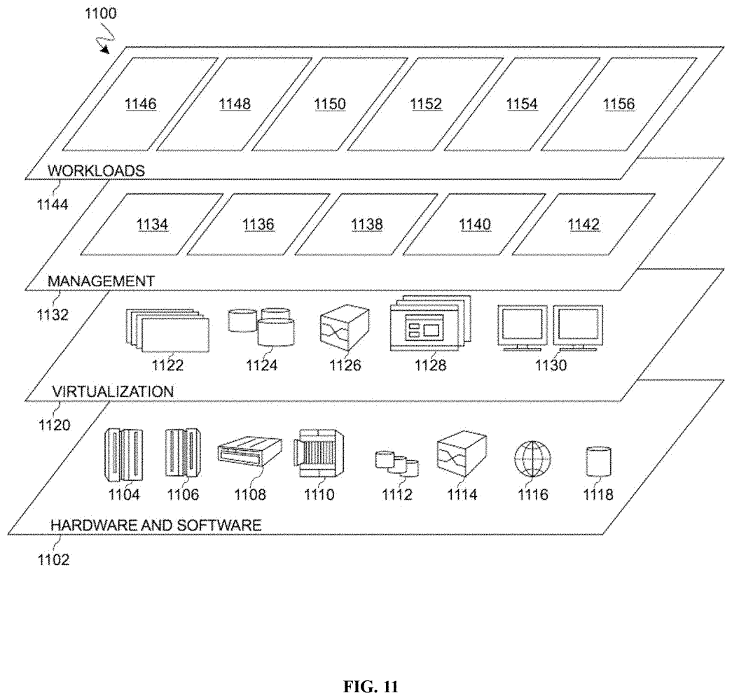

Referring now to FIG. 11, a set of functional abstraction layers 1100 provided by cloud computing environment 1000 is shown. It should be understood in advance that the components, layers, and functions shown in FIG. 11 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual exclusive networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and data management 1156.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for performing an interactive outcome analysis, comprising:
generating, by a computer, a first estimation outcome from a first plurality of input conditions;
generating, by the computer, a parallel estimation outcome from a second plurality of input conditions, wherein at least one of said input conditions in said first plurality of input conditions is different from any of said second plurality of input conditions;
selecting, by the computer, either said first or said parallel estimation outcome by analyzing said outcomes with one another and with a target goal outcome.

2. The method of claim 1, wherein a comparison result is generated between said first and said parallel estimation outcome for analysis.

3. The method of claim 2 further comprising
generating, by the computer, a rendering of said comparison result.

4. The method of claim 1, wherein a simulator provides said first estimation outcome and said parallel estimation outcome.

5. The method of claim 4, further comprising generating an individual conditional expected value based on a plurality of parameters.

6. The method of claim 5, wherein said simulator uses said individual conditional expected value to generate at least said first or said parallel estimation outcomes.

7. The method of claim 4, wherein any of said first input conditions can be changed interactively.

8. The method of claim 4, wherein said first input conditions are interactively changed until a final target goal outcome can be generated.

9. The method of claim 8, further comprising:
performing, by the computer, a batch evaluation simulation so as to generate input conditions that can provide a target goal outcome.

10. The method of claim 4, wherein said first input is changed continuously and interactively until a specific value is achieved for said first estimation outcome.

11. The method of claim 4, further comprising:
interactively rating, by the computer, said first outcome result based on said interactive change to any of said first input.

12. The method of claim 11, further comprising
generating, by the computer, a rendering of said comparison result, wherein said rendering provides a side-by-side comparison graphic of said first and parallel outcome, and
said change to said input can be provided using a drag and drop menu on said rendering.

13. The method of claim 1, further comprising:
generating a comparison result between said first and said parallel outcome results.

14. The method of claim 13, wherein said comparison result is rendered.

15. The method of claim 14, wherein said rendered comparison result includes at least one turning point, said turning point being a deviation point affecting an outcome difference between said first estimation outcome and said parallel estimation outcome.

16. The method of claim 13, wherein a plurality of turning points are generated and each of said turning point can be associated with at least one difference in said input conditions between said first and second plurality of input conditions.

17. The method of claim 1, wherein a plurality of parallel estimation outcomes are generated for a plurality of different input conditions and wherein at least one input condition is different in each plurality of parallel estimation outcomes from one another and said first input conditions.

18. The method of claim 16, wherein generating said plurality of turning points further comprises:
determining, by the computer, when said turning points were caused by at least one input; and
determining, by the computer, when changing said at least one input will cause a change in an associated output so that said associated output becomes closer in value with said target goal output.

19. A computer system, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating, by a computer, a first estimation outcome from a first plurality of input conditions;
generating, by the computer, a parallel estimation outcome from a second plurality of input conditions, wherein at least one of said input conditions in said first plurality of input conditions is different from any of said second plurality of input conditions;
selecting, by the computer, either said first or said parallel estimation outcome by analyzing said outcomes with one another and with a target goal outcome.

20. A computer program product, comprising:
one or more non-transitory computer-readable storage media and program instructions stored on at least one of the one or more tangible storage media, the program instructions executable by a processor to cause the processor to perform a method comprising:
generating, by a computer, a first estimation outcome from a first plurality of input conditions;
generating, by the computer, a parallel estimation outcome from a second plurality of input conditions, wherein at least one of said input conditions in said first plurality of input conditions is different from any of said second plurality of input conditions;
selecting, by the computer, either said first or said parallel estimation outcome by analyzing said outcomes with one another and with a target goal outcome.
